(19) United States
(12) Patent Application Publication
(10) Pub. No.: US 2005/0165956 A1
(43) Pub. Date: Jul. 28, 2005

(54) MAC controller of network printing device and method for enlarging bus bandwidth of network printing device

(75) Inventor: Hyuck-Jae Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/037,148

(22) Filed: Jan. 19, 2005

(30) Foreign Application Priority Data
Jan. 27, 2004 (KR) 2004-5189

(51) Int. Cl. G06F 15/173

(52) U.S. Cl. 709/238

(57) ABSTRACT

Disclosed is a MAC controller of a network printing device having a MAC controller for transmitting/receiving a packet over a network, and at least one bus master. The MAC controller includes a buffer for temporarily storing the packet, and an IP header analyzer for analyzing an IP header of the packet stored in the buffer, comparing an IP address of the packet with a pre-assigned IP address, and determining based on the comparison result, whether to receive the packet. The MAC controller can be advantageously used for maximizing the bus bandwidth for use in the network printing device having a single processor by minimizing unnecessary packets' accesses.

### CROSS-REFERENCE TO RELATED APPLICATIONS

This application claims the benefit under 35 U.S.C. § 119(a) from Korean Patent Application No. 2004-5189, entitled “MAC Controller of Network Printing Device and Method For Enlarging Bus Bandwidth of Network Printing Device”, filed on Jan. 27, 2004, the entire contents of which are incorporated herein by reference.

### BACKGROUND OF THE INVENTION

1. Field of the Invention

The present invention relates in general to a network controller of a network printing device. More specifically, the present invention relates to a network controller for enlarging an internal bus bandwidth of a network printing device having a single processor.

2. Description of the Related Art

In general, network printing devices including, for example, printers, scanners, and printer combos, that are connected to a network such as a (LAN) local area network often receive unnecessary packets from the network. Other printing devices that have a one-to-one connection with a host computer through a universal serial bus (USB) port, IEEE1284, or IEEE1394 interface do not receive unnecessary network packets. For instance, if a printer server is connected to the network, a confirmation packet determining whether the printing device is a file system is often broadcast to the network printing device. In particular, when a packet between networked peripheral devices is received, the network printing device has to check whether the received packet belongs to itself. When the network printing device receives an unnecessary packet, it must confirm if the received packet is its own. In doing so, the bus bandwidth of the network printing device is inevitably decreased.

FIG. 1 is a conceptual block diagram showing a conventional network printing device. The network printing device shown in FIG. 1 includes a MAC controller 100, a processor (CPU) 200, a main memory (DRAM) 600, a graphic processor 300, a rasterizer 400, and an engine 500. A BUS interconnects the MAC controller 100, graphic processor 300, rasterizer 400, CPU 200 and DRAM 600. The engine 500 is connected to the rasterizer 400.

The MAC controller 100 is connected to the network according to IEEE802.3 protocol, and performs data communication with the network. The MAC controller 100 receives a packet from the network, separates a packet header from the received packet, and applies the header to the DRAM 600 by means of the BUS.

If the received packet to the MAC controller 100 is print data, the processor (or CPU) 200 converts the print data into an object, and temporarily saves it in the DRAM 600. The graphic processor 300 converts the object saved in the DRAM 600 into bit-map data appropriate for the printing device, and applies this converted bit-map packet to the rasterizer 400 via the BUS.

The rasterizer 400 serially transmits the bit-map packet to the engine 500, and the engine 500 embodies an image out of the serially transmitted bit-map data from the rasterizer 400. The graphic processor 300, CPU 200, and MAC controller 100 of the network printing device are called bus masters because they, if necessary to execute their functions, can directly access the DRAM 600, and are entitled or authorized to use the BUS to make the direct access to the DRAM 600.

Each bus master, if necessary, can access the DRAM 600, and when it does, the bus becomes occupied by the device (one of graphic processor, processor, and MAC controller) that made the access to the DRAM 600. When a serial packet is applied to the MAC controller 100, the MAC controller 100 converts the serial packet into parallel data, and temporarily stores it in an internal buffer (not shown). Later, the data in the internal buffer is packed by a packet buffer chain, and is transmitted through direct memory access (DMA) directly to the DRAM 600 without going through the CPU 200.

After the packet is received, the MAC controller 100 determines whether a hardware address included in the data that is applied over the network is its own hardware address. If not, the MAC controller 100 does not transmit the packet to the DRAM 600. For example, when the transmitted packet transmitted over the network does not have an address of the MAC controller 100 according to the IEEE802.3 protocol, the MAC controller 100 does not transmit the packet to the DRAM 600, but instead discards or deletes the packet.

Once the packet is saved in the DRAM 600, an interrupter for processing the packet is generated, and the packet is processed by a program in the CPU 600 according to the packet's layer. In this case, it is the CPU 200 that is involved with transmission of the packet data saved in the DRAM 600, so the BUS becomes occupied by the CPU 200.

Alternatively, when a packet following TCP/IP protocol is applied to the MAC controller from the network, the MAC controller 100 transmits the packet to the DRAM 600, and the CPU 200 transfers a buffer pointer to the IP layer program through streamer software. In the IP layer program, if it turns out that the address of the packet belongs to the MAC controller 100, a packet header is separated from the packet following TCP/IP protocol, and the packet (without the header) is combined with the MAC controller 100.

If the packet in the DRAM 600 is not for the MAC controller 100, however, processing for the packet is interrupted, and the packet is deleted. Although the packet is not for the MAC controller 100, the CPU 200 occupies the bus any way to process the packet saved in the DRAM 600, so the bus bandwidth of the network printing device is decreased.

Moreover, when a broadcast packet is frequently routed from a networked host like a server (not shown), the network printing device has to do whatever is required of the broadcast packet in response. Therefore, the CPU 200 and the DRAM 600 of the network printing device, and the BUS are required to perform unnecessary tasks besides the interpretation and rendering of the print data. This consequently imposes a number of problems, such as a decreased bus bandwidth of the network printing device and deterioration in the work performance of the network printing device.

It is possible to prevent the broadcast packet from applying to the network printing device. When the user first connects the network printing device to the network, however, a network printer server might not be able to recognize even the broadcast packet sent to the network for the confirmation of the network printing device, so the user cannot use the network printing device at all.

### SUMMARY OF THE INVENTION

It is, therefore, an object of the present invention to provide a MAC controller of a network printing device having a single processor and a method for enlarging bus bandwidth of the network printing device by blocking an unnecessary packet from accessing the network printer.

To achieve the above objects and advantages, there is provided a MAC controller in a network printing device which has at least one bus master. The MAC controller transmits/receives packets over the network, and comprises a buffer for temporarily storing the packet, and an IP header analyzer for analyzing an IP header of the packet stored in the buffer, comparing an IP address of the packet with a pre-assigned IP address, and deciding based on the comparison result whether to receive the packet.

In accordance with an exemplary embodiment of the present invention, the MAC controller further comprises an address resolution protocol (ARP) header analyzer for detecting an ARP packet in the packet temporarily stored in the buffer. If the ARP packet is detected, the ARP header analyzer compares an IP address of the detected ARP packet with the pre-assigned IP address, and if the IP address of the ARP packet coincides with the pre-assigned IP address, the ARP header analyzer generates an ARP ACK packet and transmits the ARP ACK packet over the network.

In accordance with an exemplary embodiment of the present invention, the MAC controller further comprises a register for storing the IP addresses that are pre-assigned to the IP header analyzer and the ARP header analyzer. The MAC controller further comprises an interface for converting a serial packet applied through the network into a parallel packet of a nibble unit, and a DMA controller for DMA transmitting the packet in the buffer to a main memory (DRAM) in the network printing device.

Another aspect of the present invention provides a method for enlarging bus bandwidth of a network printing device having a main memory and a single processor, the method comprising analyzing an IP header of a packet transmitted over a network, and comparing an IP address of the packet with a pre-assigned IP address to the network printing device, buffering the packet if the IP address of the packet coincides with the pre-assigned IP address, and deleting the packet, if the IP address of the packet does not coincide with the pre-assigned IP address, and DMA transmitting the buffered packet to the main memory.

According to an embodiment of the present invention, the method further comprises deciding whether the transmitted packet over the network is an ARP packet; and if the transmitted packet is the ARP packet, transmitting an ARP ACK packet over the network. Preferably, the analysis of the IP header of the transmitted packet includes the sub-steps of: deciding whether the transmitted packet is a broadcast packet; and if the transmitted packet is the broadcast packet, deleting the packet. The deciding step, according to an embodiment of the present invention, comprises detecting the ARP packet in the transmitted packet, and comparing the IP address of the detected ARP packet with the pre-assigned IP address to the network printing device. The transmitting step comprises buffering the ARP packet, and providing a PHY address of the network printing device to an ARP region of the buffered packet, and transmitting the ARP ACK packet over the network.

### BRIEF DESCRIPTION OF THE DRAWINGS

The above aspects and features of the present invention will be more apparent by describing certain embodiments of the present invention with reference to the accompanying drawings, in which:

FIG. 1 is a block diagram illustrating a conventional network printing device;

FIG. 2 illustrates a packet address system following TCP/IP protocol for transmitting a packet over a network, according to an embodiment of the present invention;

FIG. 3 illustrates a header structure of an IP packet, according to an embodiment of the present invention;

FIG. 4 is an internal block diagram of a MAC controller and peripheral devices thereof, according to an embodiment of the present invention;

FIG. 5 illustrates an ARP packet structure according to an embodiment of the present invention; and

FIG. 6 is a flow chart describing a method for enlarging bus bandwidth of a network printing device according to an exemplary embodiment of the present invention.

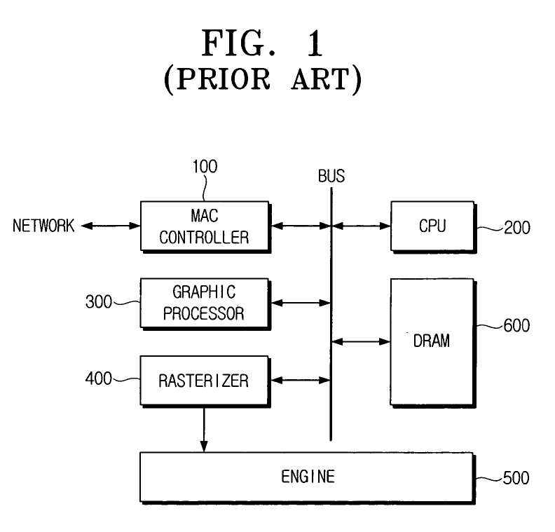

### DETAILED DESCRIPTION OF THE EXEMPLARY EMBODIMENTS

Several embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein have been omitted for conciseness and clarity.

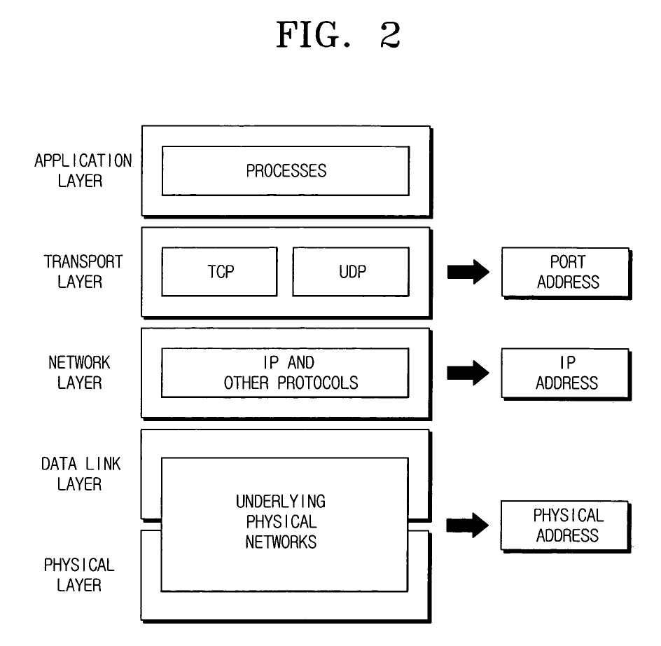

FIG. 2 illustrates a packet address system following TCP/IP protocol for transmitting a packet over a network. As shown in FIG. 2, the TCP/IP protocol is given three different addresses: the physical (PHY) address, the Internet Protocol (IP) address, and the port address. The physical address is an address of a node defined on the LAN or WAN, and is usually for use in an Ethernet card. The physical address can be unicast, multicast, and broadcast.

Unicast addresses are used to access a single device (e.g., a network printing device) through a network, and broadcast addresses are used to access every device connected to the network. The same physical address is not allowed to access different networks. IP addresses are used to identify hosts connected to different networks, and are generally composed of four one-byte fields of binary values separated by a decimal point(e.g., 132.24.75.9).

Port addresses are given to ports that a processor of a networked device can receive. Normally, a processor runs multiple processes, and it is necessary to identify a process for use in communication with the network. That is, a port address is an address for identifying a process involved in the network.

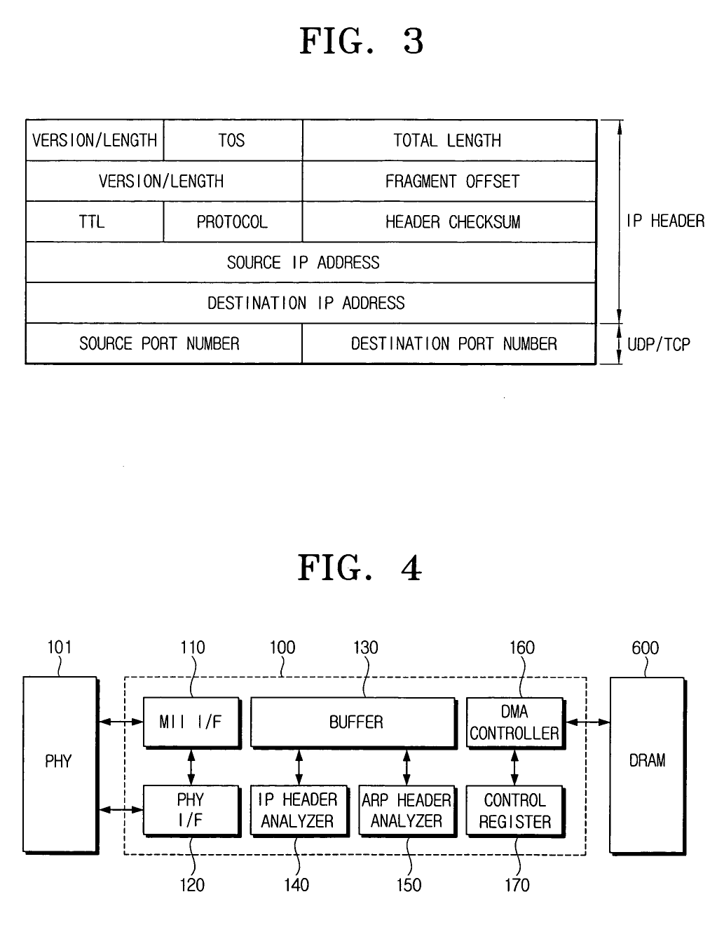

FIG. 3 illustrates a header structure of an IP packet. Version indicates a version of the IP protocol (i.e., the format of the Internet header). TOS indicates type of service, specifying the treatment of the data during its transmission through the network, and is composed of 4 bits. For example, TOS set to “0000” denotes ‘normal transfer’, “0001” denotes ‘minimum loss’, “0010” denotes ‘maximum reliability’, “0100” denotes ‘maximum throuput’, and “1000” denotes ‘minimum delay’.

Total length, in bytes, is the combined length of the header and the data. TTL (time to live) refers to the lifespan of a packet, and means the number of hops/links which the packet may be routed over. If TTL=0, the packet is expired. Protocol defines upper layer protocols using an IP layer. Examples of protocols that can be defined in this field are TCP, UDP, ICMP, and IGMP. Destination IP Address is the IP address of the final destination (the target) of the packet. This value remains unchanged while the packet is transmitted from a host (such as, a server connected to the network) to the target (such as, the network printing device). Discussion of the other header fields will not be provided here for the purpose of conciseness, as those of ordinary skill in the art would understand their function.

FIG. 4 is an internal block diagram of the MAC controller according to an embodiment of the present invention and peripheral devices thereof. As shown in FIG. 4, the MAC controller includes an MII interface (I/F) 110, a PHY interface (I/F) 120, a buffer 130, an IP header analyzer 140, an ARP header analyzer 150, a DMA controller 160, and a control register 170.

A PHY chip 101 is connected to the network, and receives packets from the network according to IEEE802.3 protocol, or converts an output packet from the PHY I/F 120 into an 802.3 packet and transmits the converted packet over the network. The MII I/F 110 converts a serial packet from the PHY chip 101 into a 4-bit nibble, and transmits the packet to the buffer 130.

The IP header analyzer 140 analyzes the header of the packet that is converted through the MII I/F 110 into a 4-bit nibble, and decides whether the packet address is a unicast address. If it turns out that the packet address is in a unicast IP address format with no specifically assigned address, the IP header analyzer 140 deletes the packet that had been converted into a 4-bit nibble. If, however, the packet address is a unicast address and PHY address of the MAC controller, the IP header analyzer 140 stores the packet in the buffer 130.

If the received packet is an IP packet, the IP header analyzer 140 decides whether the IP address of the received IP packet is identical as the IP address assigned to the device with the embedded IP header analyzer 140 (e.g., the network printing device). If the IP address of the received IP packet is the same as the IP address assigned to the device, the IP header analyzer 140 finds out whether the header size of the received IP packet corresponds to that of a normal IP packet.

If the packet header of the received IP packet comprises 20 bytes, which is the same as the normal IP packet, the IP header analyzer 140 detects the UDP and TCP packets in the received IP packet, and detects a target port address from the detected TCP packet. This target port address can belong to one process out of a plurality of processes performed by the CPU 200 in the network printing device, and if this is the case, the IP header analyzer 140 transmits the port address to the buffer 130. If, however, there is no process corresponding to the target port address, the IP header analyzer 140 removes the target port address.

Since the number of arrays of the control register 170 is limited, every port address in the packet is not compared. As described before, when the packet IP address the IP header analyzer 140 detects is a unicast address but not an IP address for the network printing device, the IP packet is deleted. This is because the network printing device is neither a router nor a gateway, and the IP packet does not need to be forwarded to another host.

If the received packet is an ARP packet, the ARP header analyzer 150 analyzes whether the address of the transmitted ARP packet coincides with a corresponding IP address. If yes, the ARP packet is transmitted to the buffer 130, but if not, the packet is deleted. According to the address resolution protocol (ARP), if a host (e.g., server) or a router does not know the destination PHY address of a packet receiver, the destinated device or the receiver is requested to give its PHY address to the host or the router. When a packet including an ARP packet is transmitted, the receiver-side device takes care of the packets, and sends its PHY address in response.

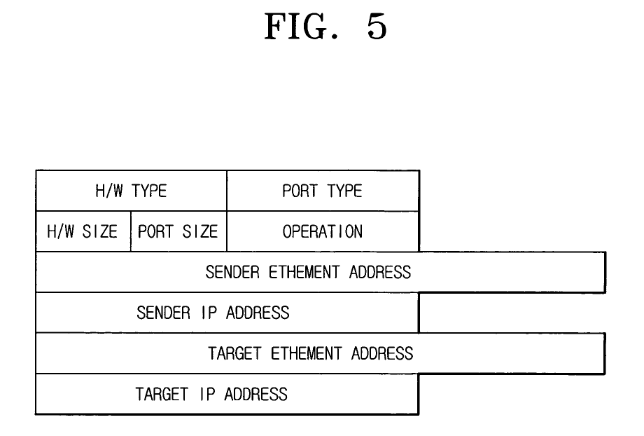

The structure of an ARP packet is illustrated in FIG. 5. Referring to FIG. 5, H/W type indicates type of network that embodies the ARP, Prot type indicates type of network protocol that embodies the ARP and Sender Ethernet address indicates a PHY address of a sender (e.g., a host like a server). The Target Ethernet address of the ARP packet indicates a PHY address of a target (e.g., the MAC controller of the embodiments of the present invention) that is defined by a host.

Here, the target Ethernet address is set “0” for the packet transmission over the network because the PHY address of the target is unknown. Also, there are other functions in the ARP packet, such as transmission of the target IP address and the IP address, which are not discussed because they are not required to understand the embodiments of the present invention.

The ARP header analyzer 150 analyzes the transmitted packet over the network to detect the presence of an ARP packet therein. If there is an ARP packet and if the address the ARP packet is looking for corresponds to the pre-assigned IP address or the IP address assigned to the network printing device, the ARP header analyzer 150 stores the ARP packet in the buffer 130, but if not, it deletes the packet. Instead of transmitting the ARP packet in the buffer 130 to the DRAM 600, the ARP header analyzer 150 generates an ARP ACK packet having the PHY address of the PHY chip 101, converts it to the packet that embodies IEEE802.3 protocol, and retransmits the 802.3 packet to the network. The ARP ACK packet transmitted over the network is transmitted to a host (e.g., a server), and the host recognizes the PHY address of the target in the ARP ACK packet.

Therefore, packets that are not directly related to the network printing device are filtered and deleted by the IP header analyzer 140 and the ARP header analyzer 150. The packets that are applied to the DRAM 600 through the DMA controller 160 are mostly from the host (e.g., the server or the PC). Thus, the BUS for use in the network printing device is no longer used for analysis of unnecessary packets, and as a result, the bus bandwidth for a print packet received from the host is subsequently increased.

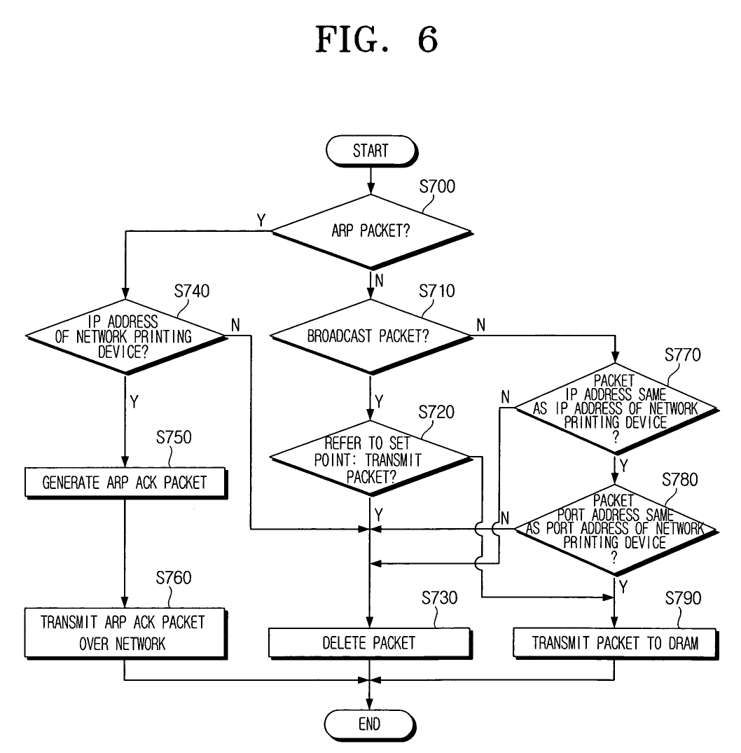

FIG. 6 is a flow chart describing a method for enlarging bus bandwidth of the network printing device according to an exemplary embodiment of the present invention. The method according to an embodiment of the present invention begins when the ARP header analyzer 150 determines whether a received packet through the MII I/F 110 includes an ARP packet (decision step S700). If so, the ARP header analyzer 150 decides that the received packet is the ARP packet (“Yes” path from decision step S700), and compares the IP address in the ARP packet with the pre-assigned IP address to the network printing device in decision step S740.

If the IP address in the ARP packet is the same as the IP address assigned to the network printing device (“Yes path from decision step S740), the ARP header analyzer 150 generates an ARP ACK packet and transmits the ARP ACK packet over the network to a host (e.g., a server) in step S760. If, however, the received packet through the Mu I/F 110 does not include the ARP packet (“No” path from decision step 700), the IP header analyzer 140 analyzes the header of the received packet to decide if it is a broadcast packet in decision step S710.

If the received packet is a broadcast packet (“Yes” path from decision step S710), the IP header analyzer 140 refers to the set point in the control register 170 (decision step S720), and decides whether or not to transmit the broadcast packet. If the set point of the control register says to block the broadcast packet, the broadcast packet is not transmitted to the DRAM 600 (“No” path from decision step S720), but is deleted (step S730). Otherwise, the broadcast packet is transmitted to the DRAM 600 (step 790).

Referring back to decision step S710, if the received packet is not a broadcast packet (“No” path from decision step S710), the IP header analyzer 140 determines whether the received packet is either a unicast packet or a multicast packet, and also determines whether the packet IP address is the same as the IP address assigned to the network printing device (decision step S770).

If the IP addresses are not the same, the IP header analyzer 140 decides that the received packet is not related and is therefore unnecessary to the network printing device (“No” path from decision step S770), so it deletes the packet (S730). If, however, the IP addresses are the same (“Yes” path from decision step S770), the IP header analyzer 140 compares the port address in the received packet with the port address assigned to the network printing device (decision step S780).

If the port address in the received packet is the same as the port address assigned to the network printing device (“Yes” path from decision step S780), the IP header analyzer 140 transmits the packet to the DRAM 600 through the DMA controller 160 (S790). If the port address of the received packet is not the same as the port address of the network printing device (“No” path from decision step S780), the packet is deleted (S730). Therefore, the MAC controller 100, according to an embodiment of the present invention blocks the DMA transmission of unnecessary packets over the network to the DRAM 600 as much as possible, so that even in a network printing device having a low-cost single processor, the bus bandwidth between the bus master (e.g., the CPU 200), and the DRAM 600 can be maximized.

The embodiments of the present invention can be advantageously used for maximizing the bus bandwidth for use in the network printing device with a single processor, by minimizing unnecessary packets' accesses to the network printing device.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A MAC controller in a network printing device that has at least one bus master, the MAC controller transmitting/receiving a packet over a network, comprising:
a buffer for temporarily storing the packet; and
an IP header analyzer for analyzing an 1P header of the packet stored in the buffer, comparing an IP address of the packet with a pre-assigned IP address, and deciding based on the comparison result whether to receive the packet.

2. The MAC controller according to claim 1, further comprising:
an ARP header analyzer for detecting an ARP packet in the packet temporarily stored in the buffer, and if the ARP packet is detected, comparing an IP address of the detected ARP packet with the pre-assigned IP address, and if the IP address of the ARP packet coincides with the pre-assigned IP address, generating an ARP ACK packet and transmitting the ARP ACK packet over the network.

3. The MAC controller according to claim 2, further comprising:
a register for storing the IP addresses that are pre-assigned to the IP header analyzer and the ARP header analyzer.

4. The MAC controller according to claim 1, further comprising:
an interface unit for converting a serial packet applied through the network into a nibble packet.

5. The MAC controller according to claim 1, further comprising:
a DMA controller for DMA transmitting the packet in the buffer to a main memory in the network printing device.

6. A method for enlarging bus bandwidth of a network printing device having a main memory and a single processor, the method comprising:
analyzing an IP header of a packet transmitted over a network, and comparing an IP address of the packet with a pre-assigned IP address to the network printing device;
if the IP address of the packet coincides with the pre-assigned IP address, buffering the packet, and deleting the packet otherwise; and
DMA transmitting the buffered packet to the main memory.

7. The method according to claim 6, wherein the step of analyzing the IP header of the transmitted packet comprises:
deciding whether the transmitted packet is a broadcast packet; and
if the transmitted packet is the broadcast packet, deleting the packet.

8. The method according to claim 6, further comprising the steps of:
deciding whether the transmitted packet over the network is an ARP packet; and
if the transmitted packet is the ARP packet, transmitting an ARP ACK packet over the network.

9. The method according to claim 8, wherein the step of deciding comprises:
detecting the ARP packet in the transmitted packet; and
comparing the IP address of the detected ARP packet with the pre-assigned IP address of the network printing device.

10. The method according to claim 8, wherein the step of transmitting comprises:
buffering the ARP packet; and
providing a PHY address of the network printing device to an ARP region of the buffered packet, and transmitting the ARP ACK packet over the network.
